(19) United States
(12) Patent Application Publication
(10) Pub. No.: US 2017/0293920 A1
(43) Pub. Date: Oct. 12, 2017

(54) System and Method for providing validated and verifiable passenger airline survey information

(71) Applicant: Joe Leader, Atlanta, GA (US)

(72) Inventor: Joe Leader, Atlanta, GA (US)

(21) Appl. No.: 15/481,397

(22) Filed: Apr. 6, 2017

Related U.S. Application Data
(60) Provisional application No. 62/319,145, filed on Apr. 6, 2016.

(51) Int. Cl. G06Q 30/02; H04W 4/04

(52) U.S. Cl. CPC G06Q 30/0201; H04W 4/046

(57) ABSTRACT

A system and method for providing airline passenger satisfaction survey information and verifying location of the device completing the survey.

### INDEX TO RELATED APPLICATIONS

This application is a non-provisional of and claims benefit to U.S. Provisional Patent application Ser. No. 62/319,145 filed Apr. 6, 2016 the disclosure of which is incorporated herein by reference in its entirety.

### BACKGROUND OF THE INVENTION

Electronic information and communication has provided consumers a powerful tool in rating goods and services. The Internet and electronic communications also provides a degree of anonymity and allows for false and ghost reviews without any independent verification.

The present invention provides a system and method for providing validated and verifiable passenger airline survey information.

### SUMMARY OF THE INVENTION

An airline passenger survey method and system whereby the survey participants are verifiable based on location of their transmission device.

### DETAILED DESCRIPTION OF THE PREFERRED EMBODIMENT

In the current environment, there is not a system in place to validate airline flight ratings to make certain that passengers rating and Airline have actually flown a specific airline flight. On occasions, Airlines send out email and other surveys to their passengers. This places the airline in the only position to receive validated data, but that does not allow for proper third-party validation and vetting of airline ratings. For airline ratings to be verified and validated, a third-party must be enlisted as the trusted entity for data receipt.

The Validated Flight Ratings System of the present invention builds upon an existing infrastructure of third-party integration of ticket information from passengers. When a passenger books on airline ticket via any source, A Passenger Name Record (PNR) is automatically created when the ticket is created. This includes the passenger's full name, their airline of choice, the flight number, their class of service, any assigned seating, and the price paid for the ticket. When the passenger receives this information via email or mobile device, third-party services may “scrape” the PNR to gain all key attributes in a data capture. Today, this is most often used to simply provide calendar information to the individual that has booked the flight.

The Validated Flight Ratings System of the present invention takes the existing data steps and provides a third-party triangulation of data points to provide a verified and validated flight rating from an airline passenger. With the PNR information captured, there are at least two different means by which to triangulate data points to enable a passenger to conduct validated flight ratings.

The first process is while on the aircraft, a passenger with a validated PNR would be able to rate their flight via the on aircraft Internet enabled communication system. Embedded in the aircraft communication system are tracking details that allow verification that the passenger is indeed on the flight originally booked. This would enable the passenger to conduct flight ratings while in flight in a validated manner. The second methodology would be triangulated from the PNR cross-referenced with Geo located data either via GPS system or triangulated mobile device location based upon cell tower origin and destination. Mobile devices automatically report this information to applications in many instances (commonly referred to as a “ping”). The triangulation of this data cross-referenced with the PNR would enable a push notification at the end of flight when airplane mode is switched off on the mobile device. The push notification would trigger the airline passenger to rate their flight immediately upon landing to provide the most immediate insights into their passenger experience based on the flight.

In one embodiment, the survey goes directly to the system owner where information is disseminate the information after verification.

In one embodiment, the survey gets sent simultaneously to the third-party and the system owner.

In one embodiment, the system owner receives information whether a survey was completed or opted out. We have it so that it is a one click five star rating on the first screen. The second screen is optional rating five additional categories.

In one embodiment, location information is verified and if a particular passenger does not complete a survey, a survey can be sent at a later time point let's say four hours or eight hours after the flight and paired with earlier location verification.

In one embodiment, then passenger will either receive a push SMS notification to complete the survey and/or a push notification from the mobile application. When they reopen the mobile application, the application automatically will prompt them to read their last flight before continuing on to other activities inside the application.

In one embodiment, passenger information and survey responses are paired with airline loyalty programs and a particular airline can see how the loyalty program numbers are responding to surveys.

In one embodiment, the third-party verifying can also provide data and correlation as to percentage of loyalty program numbers the complete surveys and the overall satisfaction of loyalty members and Non loyalty members.

In one embodiment, the present invention is:

A system for receiving and validating consumer information specific to an airline flight, said system comprising:
a local client computer configured to locate target mobile computing devices located within a specific aircraft; a configuration to exclude mobile computing devices present outside said aircraft;
a communications query configured to initiate communication to said target mobile computing devices by providing a push notification to all said devices when airplane mode is disabled upon landing, wherein said communication being configured for the passenger to receive and transmit information about the consumer experience on their currently finishing flight;
said transmitted information including information about consumer flight experience and at least one of PNR cross-referenced with Geo located data either via GPS system or triangulated mobile device location based upon cell tower origin and destination;
providing information from said transmission to said client computer.

In one embodiment, the system is further comprising an output including verification data of said transmitted information wherein said verification includes verifying the time location and device sending said transmitted information.

In one embodiment, the client computer is configured to detect a cell transmission query from a mobile computing device within said aircraft and send said push notification before communication is initiated.

Thus the present invention represents and unconventional and non-generic combination of known elements into a novel system including verification of a person on a particular flight verification of the presence of the mobile computing device on the particular flight and information relating to the time in which survey information was completed and transferred to the client computer. As generally understood, the present invention, the client computer represents a computer system operated by a particular airline conducting the survey.

Thus, when viewed in combination, the claim limitations are more than a trivial combination of known elements or abstract ideas, but they solve a very known real-world problem and that is providing accurate and timely information relayed by airline passengers relating to their recently completed flight.

In one embodiment, the present invention includes a method for providing validated and verifiable passenger airline survey information, said method comprising the steps of:
providing a system as disclosed and described herein;
switching an Internet enabled device from airplane mode to non-airplane mode while said device is switched while a user of said device is on a recently landed airline flight;
verifying a physical location of said device by either GPS system or triangulated mobile device location based upon cell tower origin and destination;
providing a system operatively associated with said client computer on said airline flight that detects said switching;
transmitting passenger consumer survey information from said system to said device;
transmitting responses to said consumer survey information from said device to said system;
compiling an aggregate file of said consumer survey information;
providing output information of said responses and physical location.

The method steps of the present invention similarly recite a combination of steps that is nonconventional and non-generic in that there is independently verifiable data available to confirm the accuracy of survey results.

Although surveys could be taken with a pencil and a piece of paper, there is nothing that independently verifies any particular survey was completed on a specific flight at the specific time in which the flight lands. the method of the present invention does not merely gather data, but instead provides a sequence of events and method steps that address unique problems associated with collecting and verifying accurate passenger experience data.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for receiving and validating consumer information specific to an airline flight, said system comprising:
a local client computer configured to locate target mobile computing devices located within a specific aircraft;
a configuration to exclude mobile computing devices present outside said aircraft;
a communications query configured to initiate communication to said target mobile computing devices by providing a push notification to all said devices when airplane mode is disabled upon landing, wherein said communication being configured for the passenger to receive and transmit information about the consumer experience on their currently finishing flight;
said transmitted information including information about consumer flight experience and at least one of PNR cross-referenced with Geo located data either via GPS system or triangulated mobile device location based upon cell tower origin and destination;
providing information from said transmission to said client computer.

2. The system of claim 1 further comprising an output including verification data of said transmitted information wherein said verification includes verifying the time location and device sending said transmitted information.

3. The system of claim 1 wherein said client computer is configured to detect a cell transmission query from a mobile computing device within said aircraft and send said push notification before communication is initiated.

4. A method for providing validated and verifiable passenger airline survey information, said method comprising the steps of:
providing a system of claim 1;
switching an Internet enabled device from airplane mode to non-airplane mode while said device is switched while a user of said device is on a recently landed airline flight;
verifying a physical location of said device by either GPS system or triangulated mobile device location based upon cell tower origin and destination;
providing a system operatively associated with said client computer on said airline flight that detects said switching;
transmitting passenger consumer survey information from said system to said device;
transmitting responses to said consumer survey information from said device to said system;
compiling an aggregate file of said consumer survey information;
providing output information of said responses and physical location.

5. The method of claim 4 wherein said output information is provided to and verified by a third party.
